(19) United States
(12) Patent Application Publication
(10) Pub. No.: US 2011/0226199 A1
(43) Pub. Date: Sep. 22, 2011

(54) RADIAL INTERNAL COMBUSTION ENGINE WITH DIFFERENT STROKE VOLUMES

(76) Inventor: Bahman Mohtashemi, Los Gatos, CA (US)

(21) Appl. No.: 12/728,145

(22) Filed: Mar. 19, 2010

(51) Int. Cl. F02B 75/22; F02B 75/04; F02B 75/32

(52) U.S. Cl. 123/54.2; 123/48 B; 123/197.4

(57) ABSTRACT

A radial internal combustion engine employing a hypocycloidal connection between the crankshaft and the piston connecting rods, creating different stroke volumes on the intake stroke and the power stroke, thus increasing combustion excursion and saving energy.

### BACKGROUND OF THE INVENTION

1. Field of the Invention

The present invention relates generally to an internal combustion engine and more specifically to an internal-combustion engine employing reciprocating pistons in a radial design which employs a hypocycloidal connection between the crankshaft and the piston connecting rods.

2. Description of the Prior Art

Conventional internal combustion engines have four cycles, namely, intake, where air and vaporized fuel are drawn in; compression, where fuel vapor and air are compressed; combustion or power, where the compressed air and fuel ignite and expand and the piston is pushed downwards; and exhaust, where the exhaust is driven out. Each of these four cycles has an equal stroke distance and therefore the volume of the space through which the piston travels during a single stroke cycle, or displacement, is equal. The term “stroke distance” as used herein refers to the distance that a piston travels in one cycle.

At the end of combustion cycle, there is remaining residual energy (which means combustion gases are at above atmospheric pressure) in the cylinder that is wasted due to opening of exhaust valve while residual pressure remains. Also, the exhaust gas is forced out with considerable pressure, resulting in a loud sound, therefore undesirably requiring a muffler, which is naturally more costly and inconvenient.

In today's engines, due to necessity imposed by engine structure of all cycles being equal, during the combustion cycle (or stage), the travel of the piston cannot be regulated to desired length, resulting in an unnecessary waste of energy.

Therefore, the need arises for an internal combustion engine that has a larger displacement volume during the combustion cycle than the displacement volume during the intake cycle.

### SUMMARY OF THE INVENTION

Briefly, the present invention relates generally to an internal combustion engine and more specifically to a radial internal combustion engine employing a hypocycloidal connection between the crankshaft and the piston connecting rods, creating different stroke volumes on the intake stroke and the power stroke, thus increasing combustion excursion, increasing power output and saving energy.

In accordance with the various embodiments of the present invention, an internal combustion engine is disclosed having a displacement during the combustion stage that is larger than the displacement during the intake stage, thereby offering the benefit of using residual energy to increase efficiency and improve fuel conservation, reducing or eliminating the requirement for a muffler and reducing cooling system requirements due to cooler expanded burnt fuel. To attain the foregoing, a hypocycloidal system includes an inner cogwheel rotating inside of an outer annular cogwheel, with the diameter and number of teeth of the inner cogwheel being exactly one third of outer cogwheel.

In one embodiment, there is presented a four-cycle internal combustion engine assembly comprising: a housing assembly; a crankshaft disposed in the housing, the axis of rotation of the crankshaft being generally parallel to the orientation of the crankshaft; at least three cylinders radially disposed about the crankshaft axis; the crankshaft having one or more throws; an inner cogwheel rotatably mounted on the journal of each throw; each inner cogwheel having a linkage and a journal at the distal end of each linkage, each inner cogwheel having a linkage extending therefrom and a journal at the distal end of the linkage; an outer cogwheel within the housing and oriented concentric with the axis of rotation of the crankshaft; a plurality of cylinders fixed to the housing; each cylinder encompassing a piston having a connecting rod, one end of which is pivotally connected to the piston, the other end being rotatably mounted to a journal on the inner cogwheel linkage, such that as the crankshaft rotates, the axis of the lower end of the connecting rod (or cogshaft linkage journal) rotates hypocycloidally with respect to the axis of the crankshaft. The ratio of the length of the cogshaft linkage and crankshaft throw can be between 0.7 and 1.5, or more particularly, between 0.9 to 1.1, or even about 1. The ratio of the displacement of piston at the power stroke to displacement at the compression stroke can be between 2 and 7 or more particularly, between 3 and 4.

The number of cylinders can be three or a multiple of three, and the ratio of number of teeth of the outer cogwheel to the number of teeth in the inner cogwheel should be 3.

In another embodiment, there is provided a crankshaft assembly for a radial internal combustion four-cycle engine having at least three cylinders and a housing for the crankshaft assembly, comprising: a crankshaft disposed in the engine housing; an annular outer cogwheel mounted within the housing and being oriented concentric with the axis of rotation of the crankshaft; the crankshaft having at least one throw arm extending perpendicularly from the crankshaft axis; an inner cogwheel rotatably connected to each throw arm, engaging the annular cogwheel and having a cogshaft extending therefrom perpendicular to its axis of rotation; each cylinder having a piston disposed therein, with one end of the piston being pivotally connected to the outer end of a connecting rod; and the inner end of each connecting rod being rotatably attached to a cogshaft journal; whereby the crankshaft assembly allows the inner end of the connecting rod to move hypocycloidally with respect to the axis of the crankshaft, thus enabling a different piston displacement during the intake cycle compared to the combustion cycle of a four-cycle engine.

In yet another embodiment, there is provided a crankshaft assembly for a radial internal combustion engine having at least three cylinders and a housing for the crankshaft assembly, comprising: a crankshaft disposed in the engine housing, the housing having an integral annular cogwheel oriented concentric with the axis of rotation of the crankshaft, the crankshaft having at least one throw arm extending perpendicularly from the axis, an inner cogwheel rotatably connected to each throw arm and engaging the annular cogwheel, each cylinder having a piston disposed therein, with one end of the piston being pivotably connected to the outer end of a connecting rod, the inner end of each connecting rod being rotatably attached to a cogshaft journal which attaches perpendicular to the end of cogshaft which itself extends from the inner cogwheel perpendicular to its axis of rotation, whereby the crankshaft assembly allows the inner end of the connecting rod to move hypocycloidally with respect to the axis of the crankshaft, thus enabling a different piston displacement during the intake stroke as opposed to the combustion stroke.

In yet another embodiment, there is provided in a radial internal combustion engine having a housing, a plurality of pistons each pivotally connected to one end of a connecting rod, each connecting rod having a medial end spaced apart from the end connected to the piston, a crankshaft having throw arm to accommodate each piston, and a linkage between the crankshaft and the connecting rod, an improvement which comprises: the linkage for each piston comprising an inner cogwheel rotatably mounted on the throw arm, a cogshaft integral with each inner cogwheel to which is rotatably connected the medial end of the connecting rod; and an annular cogwheel within the housing with which each inner cogwheel is engaged; such that the medial end of the connecting rod moves hypocycloidally with respect to the axis of the crankshaft to enable a different piston displacement during the compression stroke as compared to the combustion stroke.

The foregoing and other objects, features and advantages of the present invention will be apparent from the following detailed description of the preferred embodiments which make reference to several figures of the drawing.

### IN THE DRAWINGS

FIG. 1 shows a cross-section view of a cylinder in an internal combustion employing a hypocycloidal crankshaft assembly.

FIG. 2 shows a schematic view of selected components of the hypocycloidal crankshaft assembly.

FIG. 3 shows a graph comparing the displacement of an engine having a hypocycloidal crankshaft assembly compared to a typical internal combustion engine as the crankshaft rotates.

FIG. 4 shows a cross-section view of a cylinder employing a hypocycloidal crankshaft assembly, in which the piston is at the end of an intake cycle.

FIG. 5a shows a cross-section view of a radial three-cylinder arrangement employing a hypocycloidal crankshaft assembly with the top piston being at the beginning of the intake cycle.

FIG. 5b shows a cross-section view of a radial three-cylinder arrangement employing a hypocycloidal crankshaft assembly with the top piston being at the beginning of the compression cycle.

FIG. 5c shows a cross-section view of a radial three-cylinder arrangement employing a hypocycloidal crankshaft assembly with the top piston being at the beginning of the power cycle.

FIG. 5d shows a cross-section view of a radial three-cylinder arrangement employing a hypocycloidal crankshaft assembly with the top piston being at the beginning of the exhaust cycle.

FIG. 6 shows a cross-sectional view of four representative positions of a cogwheel assembly.

FIG. 7 shows a diagram of the relative relationships between the connecting rod, the cogshaft and the crank throw in an engine.

FIG. 8 shows a plan view diagram of the relative positions of the connecting rod, the cogshaft and the crank throw as a piston moves.

FIG. 9 shows a graph of the ratio of combustion volume to intake volume for various ratios of the lengths of the cogshaft linkage and crank throw.

FIG. 10 shows a graph of the positions of the cogshaft journal axis or connecting rod bearing axis as a piston completes its four cycles.

FIG. 11 shows a plan view diagram of the relative positions of a bank of three pistons employing a hypocycloidal crankshaft assembly.

FIG. 12 shows a pressure—volume diagram comparison for a regular cylinder and one employing a hypocycloidal crankshaft assembly.

FIG. 13 shows a cross section of a cogwheel linkage assembly for adjacent banks of three cylinders employing a hypocycloidal crankshaft assembly.

FIG. 14 shows an expanded view of the cogwheel linkage assembly.

FIG. 15 is a side view of a two-bank depiction of the hypocycloid crankshaft assembly.

FIG. 16 is a perspective view of a two-bank depiction of the hypocycloid crankshaft assembly showing the interbank hypocycloid gearing.

FIG. 17 is an expanded perspective view of the interbank hypocycloid gearing.

### DETAILED DESCRIPTION OF THE PREFERRED EMBODIMENTS

In accordance with the various embodiments of the present invention, an internal combustion engine is disclosed having a displacement during the combustion stage that is larger than the displacement during the intake stage volume, thereby offering the benefits of using residual energy to increase efficiency and improve fuel conservation, reducing or eliminating the requirement for a muffler and reducing cooling system requirements due to cooler expanded burnt fuel. To attain the foregoing, in one embodiment, a hypocycloidal crankshaft assembly system includes an inner cogwheel rotating inside of an outer annular cogwheel, with the diameter and number of teeth of the inner cogwheel being substantially one third that of the outer cogwheel.

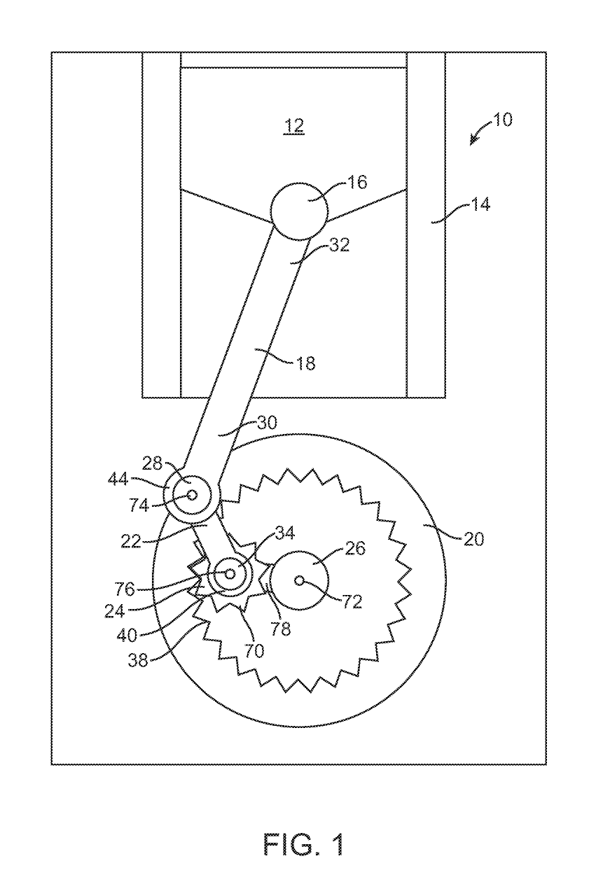

Referring now to FIG. 1, a planar top view of a hypocycloidal crankshaft assembly system 10 is shown in accordance with an embodiment of the present invention. The system 10 is shown to include conventional piston 12 housed within cylinder 14 with the former moving up and down in a reciprocal pattern inside the cylinder 14 as the engine operates and goes through its four cycles. The piston 12 is generally cylindrical in shape and is shown at its lower end 16 to be attached to upper end 32 of piston connecting rod 18, typically by a wrist pin. The lower end 30 of connecting rod 18 is rotatably connected to cogshaft journal 28 by a connecting rod bearing 44 having axis of rotation 74. The cogshaft journal 28 is linked by cogshaft linkage 22 to a cogwheel 24. Cogshaft linkage 22 is fused to cogwheel 24 and a cogwheel 24 is concentric with axis 76 of the cogwheel bearing 40.

The teeth 70 of inner cogwheel 24 engage the teeth 38 of outer annular cogwheel 20. Outer cogwheel 20 has as its center the axis 72 of rotation of the crankshaft 26. Similarly, when viewed perpendicularly to their axes of rotation, the crankshaft throw and the cogshaft linkages each have two ends as described: one common end comprising a journal 34 on the distal end of crankshaft throw arm 78 and a corresponding cogwheel bearing 40 on the cogshaft linkage 22; and the other ends at axis 72 of engine crankshaft 26, and the connecting rod bearing 44.

The piston connecting rod 18 at its end 32 is pivotally connected to the piston at its lower end 16 by a pin connecting end 32 to the bottom part of the piston 12. The lower end 30 of rod 18 generally has an annular bearing 44 which rotatably accommodates cogshaft journal 28. Cogshaft journal 28 is attached at substantially a right angle to one end of cogshaft linkage 22, and cogshaft linkage 22 at its other end is connected to a cogwheel 24 which concentrically engages cogwheel bearing 40. Cogwheel 24 engages annular outer cogwheel 20 so that as the crankshaft 26 rotates, for example in a clockwise fashion, the stationary annular cogwheel 20 will cause the inner cogwheel 24 to rotate in a counter-clockwise fashion, in turn causing the cogshaft journal 28 and the connecting rod bearing rotation axis 74 to move in a hypocycloidal fashion.

Cogwheel bearing 40 engages distal journal 34 of the crankshaft throw 78, and journal 34 is connected at substantially a right angle to the distal end of crankshaft throw 78, which in turn extends inwardly to crankshaft 26. Crankshaft 26 is connected at one end to the main work axle of the engine, transferring work to the outside.

Crankshaft throw distal journal 34 engages the cogwheel bearing 40, thereby causing the crankshaft 26 to hold the inner cogwheel 24 in position. Similarly, the inner cogwheel 24 cogshaft linkage 22 holds connecting rod 18 in position. Furthermore, movement of the inner cogwheel 24 in generally a circular or radial fashion causes the connecting rod 18 to move piston 12 up and down in a reciprocal fashion inside of the cylinder 14.

It is noted that the teeth 70 extend outwardly from the inner cogwheel 24 whereas the teeth 38 extend inwardly from annular cogwheel 20, which allows the teeth on inner cogwheel 24 to mesh with outer cogwheel teeth 38.

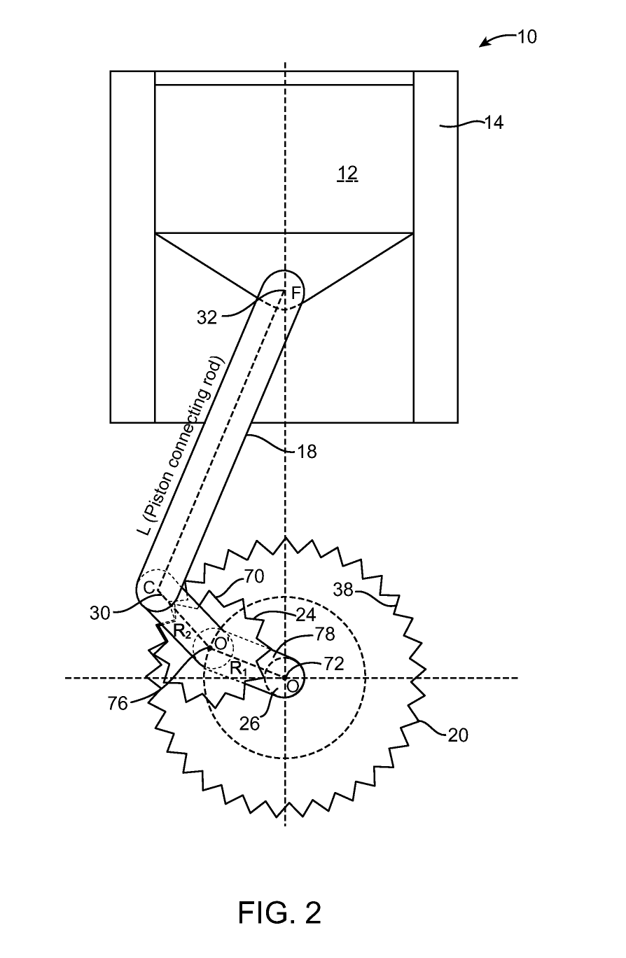

FIG. 2 shows a two-dimensional sketch of FIG. 1 where the axis of rotation of upper end 32 of the connecting rod 18 is denoted also by “F” and the axis of rotation of lower end 30 of connecting rod 18 is denoted by “C”. “O” at 72 represents the axis of rotation of crankshaft 26 and center of annular cogwheel 20. Crankshaft throw 78 rotates about O when the inner cogwheel 24 is turning inside of the outer cogwheel 20. Rotation of the crankshaft 26 causes power to be transmitted to the workshaft at O. “R1”, as used herein, refers to the distance from “O”, the crankshaft axis 72 to “O”, the cogwheel bearing axis 76. “R2”, as used herein, refers to the distance from “O”, the cogwheel bearing axis 76 to “C”, the cogshaft journal axis 74.

During operation, the inner cogwheel 24 rotates radially along the z-axis about cogwheel bearing axis 76 and around the inner portion of the outer cogwheel 20, with the inner cogwheel teeth 70 meshing with the annular cogwheel teeth 38 in a mating fashion. This movement results in the connecting rod 18 moving along the y and x axis in a manner to move the piston 12 up and down between substantially the bottom of the cylinder 14 up to substantially the top of the cylinder 14 thereby increasing the volume of the gas or displacement in the cylinder 14 to increase fuel efficiency and energy conservation.

In accordance with an exemplary embodiment where three pistons are employed, as will be shown shortly relative to subsequent figures, the number of teeth 70 on the inner cogwheel 24 is one third of the number of teeth 38. Similarly, the diameter of the inner cogwheel 24 is a one third of the diameter of the outer cogwheel 20.

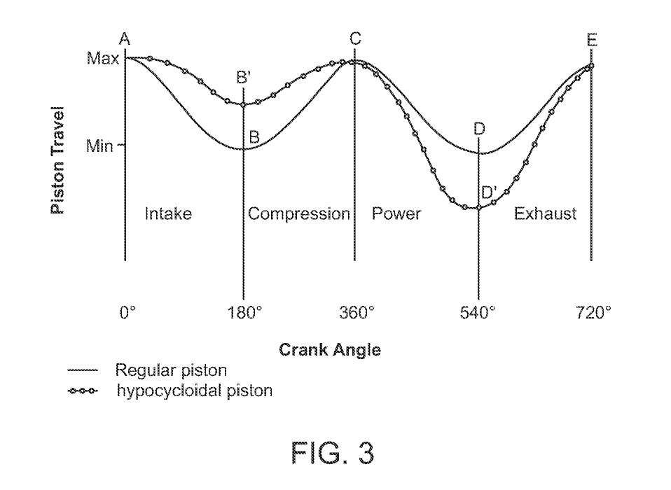

It may be instructive at this point to view a chart comparing the movement of a piston with the hypocycloidal crankshaft linkage of the present invention to that of a piston of a standard reciprocating piston engine during a typical four cycles occurring over two revolutions of the crankshaft at standard engine and one revolution of crankshaft 26 at present invention, as shown in FIG. 3. Beginning at point “A”, a crankshaft angle of 0 degrees with the piston is at top dead center and at a point of maximum elevation, as the crankshaft rotates in a clockwise fashion, a normal piston would move inwardly toward the crankshaft on the intake stroke until it reaches its lowest point, point B, then it returns in a compression stroke to point C, at which point the air-fuel mixture is ignited, and the power stroke occurs between point C and D. At point D, the piston reverses direction and moves away from the crankshaft to exhaust the combustion gasses up to point E, where the cycle begins anew. In comparison, in an engine with a hypocycloidal crank assembly, the piston moves from top dead center at point A on the intake stroke to point B′, a smaller distance than traveled by the normal piston. The piston moves from the end of the intake stroke at B′ to compress the air-fuel mixture up to point C at top dead center. There, the air-fuel mixture is ignited, and the piston travels on the power stroke to point D′ the bottom dead center, a much longer power stroke than traveled by the normal piston. From point D′, the piston returns to point E (or A) to begin the cycle anew. It can be seen that the hypocycloidal crank system allows an engine to operate with a greater fuel economy due to a smaller displacement in the intake cycle, and more power output due to an increased expansion displacement, thus extracting more work in the power cycle.

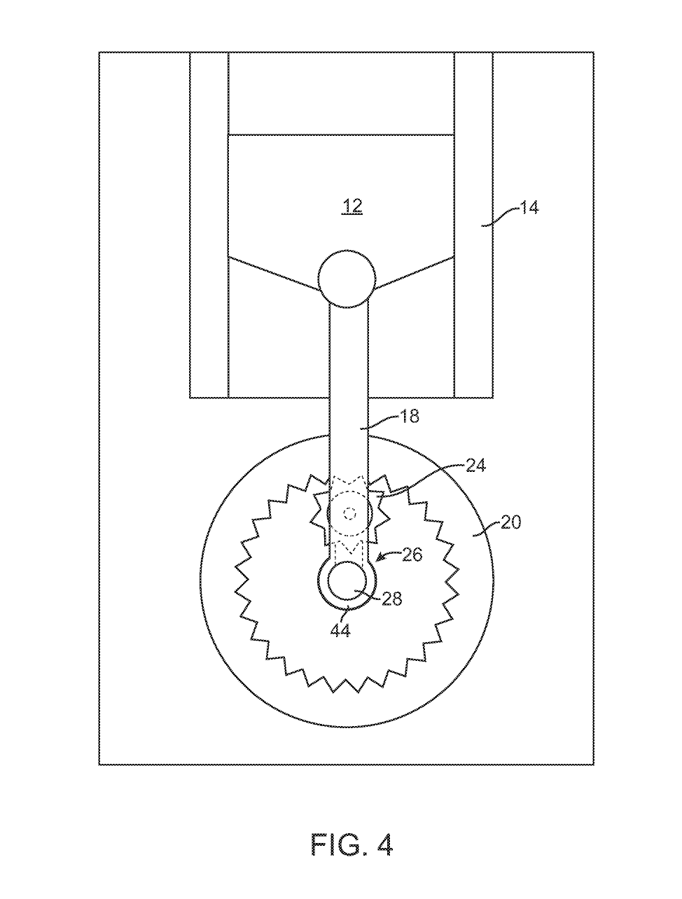

FIG. 4 shows a cross section of one cylinder in an embodiment in which the length R1 of the crankshaft throw between axes 72 and 76 is equal to R2, the length of the cogshaft between axes 76 and 74. Thus in the position shown, the crankshaft 26, which is obscured from view by the distal end of the cogshaft and the lower end of the connecting rod 18 and the connecting rod bearing 44, has moved approximately 85 degrees in a clockwise direction relative to its position in FIGS. 1 and 2 with cogwheel 24 now at its uppermost position. As shown in FIG. 4, the piston 12 has moved downwardly from its position in FIGS. 1 and 2.

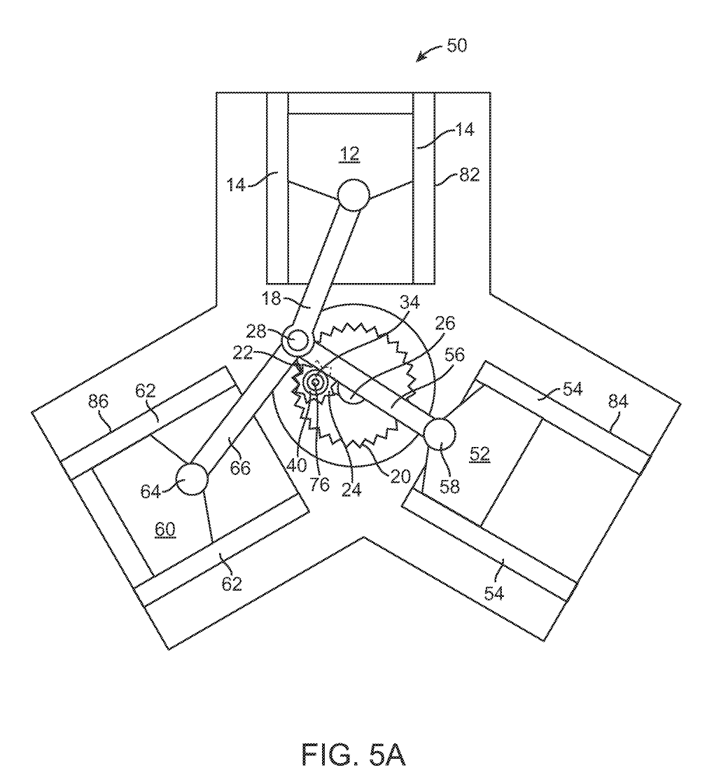

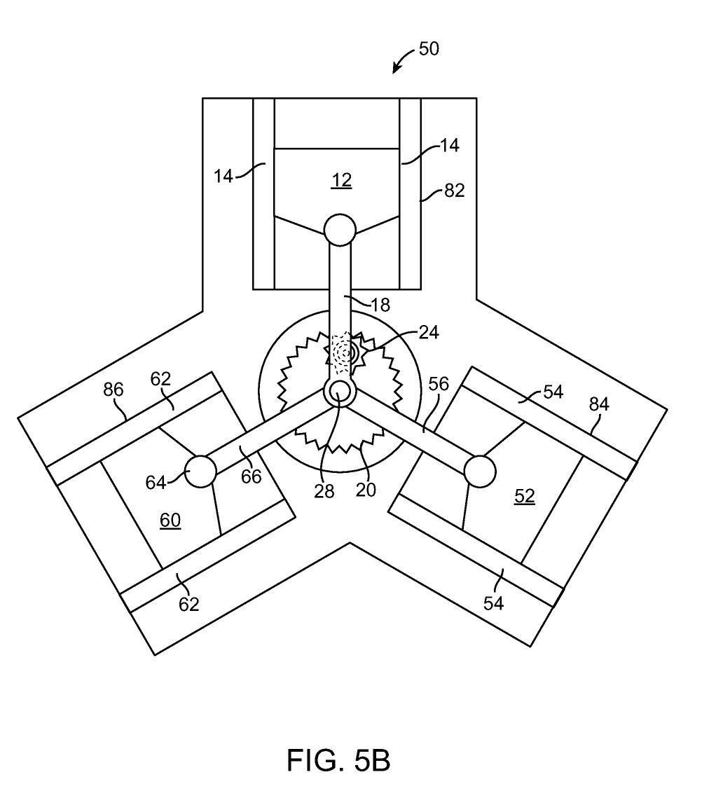

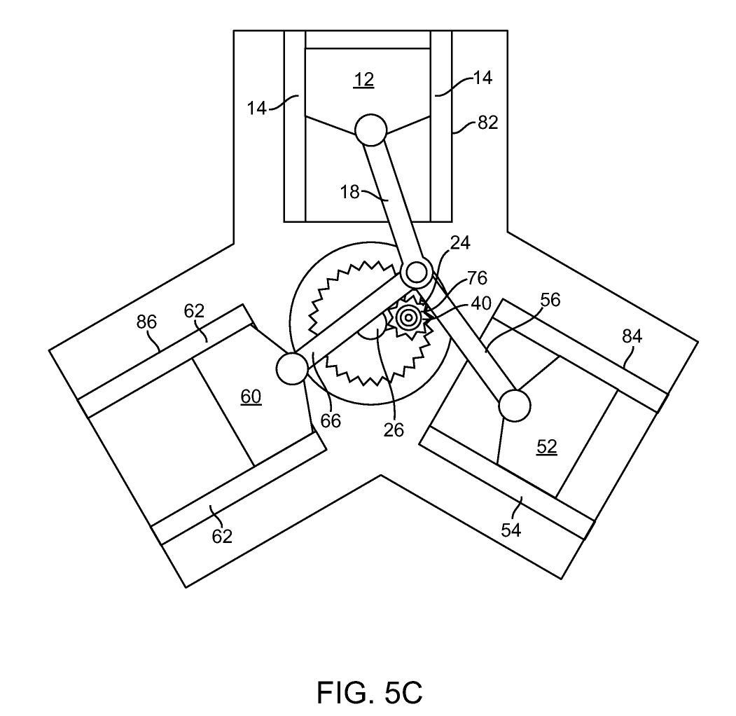

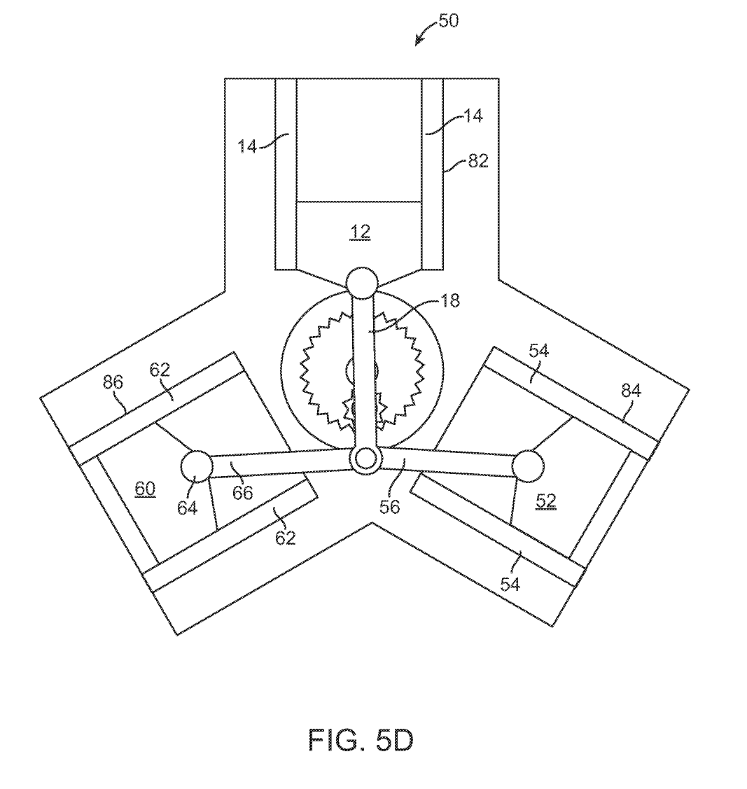

FIG. 5A shows a planar top view of a hypocycloidal system 50, in accordance with another embodiment of the present invention. Interestingly, the system 50 includes three pistons used with the inner and outer cogwheels of FIGS. 1 and 2. That is, piston 60, which is connected to piston connecting rod 66 through the piston pin at the lower end of the piston 64 moves up and down in the piston housing or cylinder 62 driven by the radial movement of the inner cogwheel 24 rotating inside of the outer cogwheel 20. Similarly, piston 52, which is connected to piston connecting rod 56 through the piston pin at lower end 58 of the piston moves up and down in the cylinder 54 with the radial movement of the inner cogwheel 24 inside of the outer cogwheel 20.

Typically, during manufacturing, the connecting rod 66 is connected at one end by a pin to the piston 60 and at the other end by a bearing to a cogwheel journal 28. Cogshaft journal 28 is linked by a cogshaft linkage 22 to cogwheel bearing 40 at an opposite end thereof, much in the same manner in which the rod connecting 18 is connected to cogshaft journal 28. Next, the third connecting rod 56 is similarly attached by a bearing to the cogshaft journal 28 at its outer end. Connection of three connecting rods to the cogshaft journal 28 could be simply arranged as one adjacent to the other, but it can also be arranged in other fashions as long as cogshaft journal 28 can be revolved easily inside the connecting rod bearings.

The piston 12, cylinder 14 and connecting rod 18 collectively form a cylinder structure 82; similarly, piston 52, cylinder 54 and connecting rod 56 collectively form a cylinder structure 84; and piston 60, cylinder 62 and connecting rod 66 collectively form a cylinder structure 86. The cylinder structure 84 is oriented 120 degrees, in a clockwise direction, from the orientation of cylinder structure 82. The cylinder structure 86 is positioned 120 degrees, in a counter clockwise direction, from the cylinder structure 82 and 120 degrees, in a clockwise direction, from the cylinder structure 84. In this manner, when viewed perpendicular to the axis of the crankshaft, each cylinder is 120 degrees offset from its neighboring cylinder.

While three cylinders are shown in FIG. 5A, it is contemplated that six or more cylinders may be employed by placing two or more banks of three-cylinder compartments side by side so that the crankshaft throw journals 34 of each bank are connected. Typically there will be an outer cogwheel conjoining two adjacent compartments, with the annular opening in the outer cogwheel allowing space for connection of crankshaft throw journal shafts 34 for each bank. The crankshaft throw journal shafts will be rotatably supported between the cylinder banks by an inner cogwheel rotatably mounted within an outer cogwheel.

The degree of angle between cylinders of two compartments relative to each other can be arranged at will by proper angulation of shafts of two compartments relative to each other, but it is assumed that the best way is coplanar arrangement of component of this complex connected crankshaft resulting each cylinder of one compartment to be 60 degrees apart from adjacent cylinder from the second compartment.

In the embodiment of FIG. 5a, piston 12 is shown to be at the beginning of an intake cycle, piston 52 is shown to be in a near end of a combustion cycle and the piston 60 is shown to be near the end of compression cycle. As the crankshaft 26 moves in a clockwise direction causing inner cogwheel 24 to rotate in a counter-clockwise direction within the outer cogwheel 20, the pistons 12, 52 and 60 each move up and down within the cylinder and each experience the four cycles of combustion.

FIGS. 5B, 5C and 5D show the various cycles of the engine as the as crankshaft rotates in a clockwise fashion and the inner cogwheel moves in a counter-clockwise fashion within the outer cogwheel in the system 50. In FIG. 5A, piston 12 is in the beginning of the intake cycle, the piston 52 is in the power cycle, and piston 60 is in the compression cycle. In FIG. 5B, piston 12 is at the end of intake cycle, piston 52 is in the exhaust cycle, and piston 60 is in the power cycle. In FIG. 5C piston 12 is at the end of the compression cycle, the piston 52 is in the intake cycle, and the piston 60 is at slightly after beginning of the exhaust cycle. In FIG. 5D, piston 12 is at the end of the combustion cycle, the piston 52 is near the end of the compression cycle, and piston 60 is in the early part of the intake cycle.

Similarly, the cycles experienced by piston 12 are as follows: in FIG. 5A, piston 12 is shown at the beginning of an intake cycle, and in FIG. 5B, at the end of the intake and beginning of the compression cycle. In FIG. 5C, piston 12 is at the end of the compression cycle and beginning of the power or combustion cycle, and in FIG. 5D, piston 12 is at the end of the power cycle and at the beginning of the exhaust cycle.

The basic design of the invented engine is based on a hypocycloidal system in which the positions of the pistons are determined by a smaller cogwheel which rotates inside a larger cogwheel. The diameter and number of teeth of the small cogwheel should be exactly one third of those of the larger cogwheel.

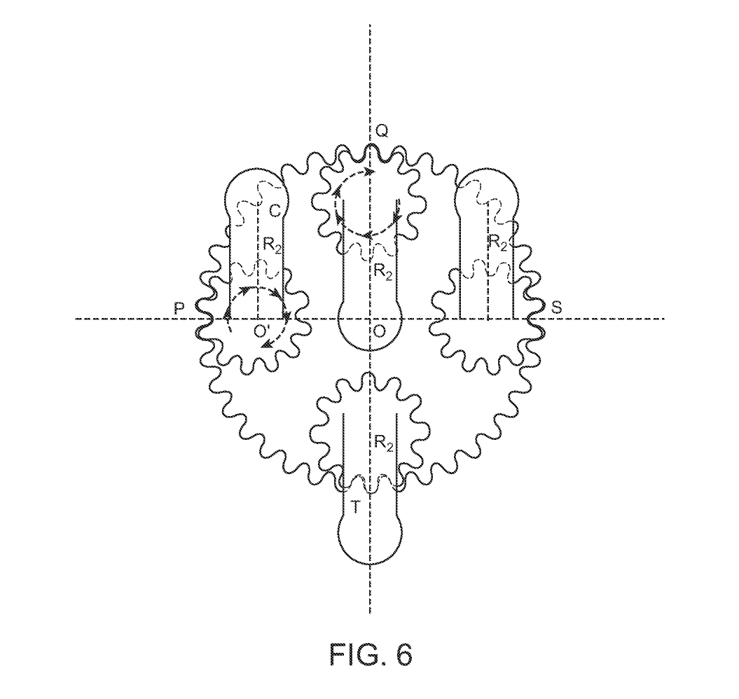

FIG. 6 below displays four positions of small cogwheel inside the large cogwheel. When small cogwheel is at point P on the outer cogwheel, cogshaft linkage O′C (R₂) points vertically upward. If the cogwheel rotates about its axis O′ in a counterclockwise direction, it will physically revolve in a clockwise direction within the outer cogwheel about axis O. When the inner cogwheel reaches point Q (90° clockwise of P on the large cogwheel), cogshaft linkage R₂ will point vertically downward. This position can be confirmed by counting the number of teeth on both cogwheels. If the number of teeth on the small cogwheel is “n”, the number of teeth on the large cogwheel naturally will be “3n” and number of teeth from P to Q will be one fourth of it or ¾ n. Thus, on FIG. 6, advancing ¾ of teeth on the small cogwheel in the direction of arrow turns the cogshaft R₂ upside down. By symmetry, if the small cogwheel turns clockwise another 90° on the large cogwheel and reaches point S, the cogshaft R₂ will be oriented vertically upward, and at point T, cogshaft R₂ is oriented vertically downward.

Naturally, position Q will be at the end of the intake cycle and position T will be at the end of combustion cycle of the engine. Positions P and S are close to ends of exhaust and compression cycles but not exactly at those states, because those states should be at highest position of piston connecting rod (top dead center) which is dependent on several factors discussed below.

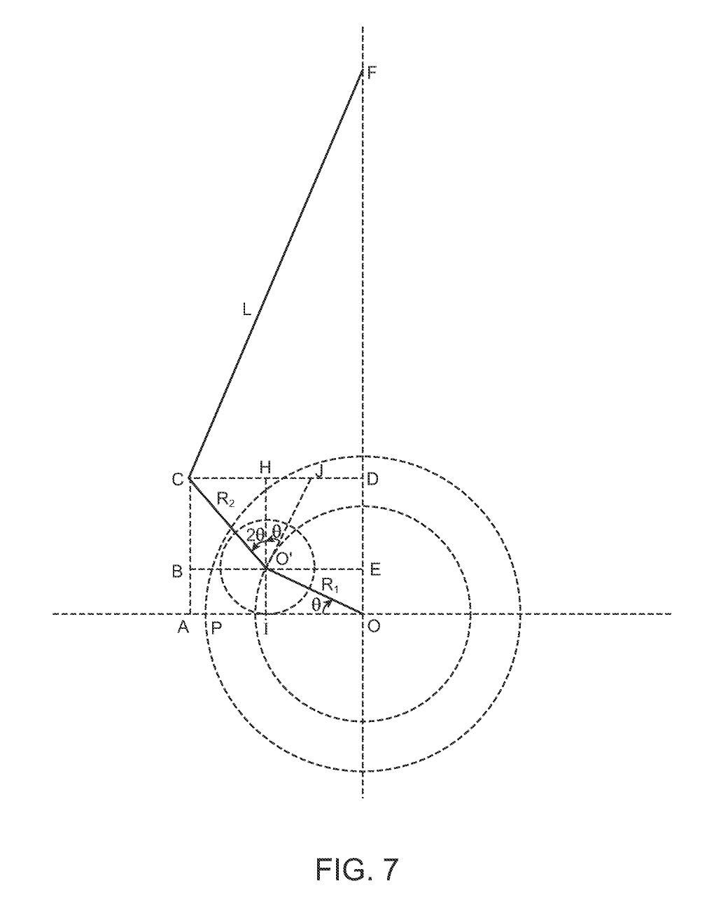

FIG. 7 is a reconstruction of FIG. 2 drawn for calculation purposes to better show the positions of different key points during movements of the crankshaft. In FIG. 7, crankshaft throw is “R₁”, the cogshaft linkage is “R₂” and piston connecting rod is shown by “L”. Starting the origin of rotation of the inner cogwheel at P, crank throw R₁ starts rotation from horizontal line clockwise with angle of θ. At this point cogshaft R₂ attached to the small cogwheel has rotated 3θ counterclockwise relative to R₁ (because the small cogwheel circumference is ⅓^{rd} of larger cogwheel). However R₁ itself has a clockwise rotation of θ. So, to calculate the net rotation of R₂ with regard to the fixed vertical line, one has to subtract (3θ−θ2θ). Thus, for every θ rotation of shaft R₁ clockwise, cogshaft R₂ rotates 2θ counterclockwise (angle CO′ H on FIG. 7). Correspondingly, for every 90° rotation of R₁ clockwise around the center O, R₂ rotates 180° counterclockwise relative to the vertical or the horizontal line and will assume the positions shown on FIG. 6.

To calculate the position of point F at the upper end of piston connecting rod with respect to the axis O of the crankshaft, i.e., the length of OF (FIG. 7), proceed as follows:

OE=O′I=R₁ sin θ

ED=O′H=R₂ cos 2θ

OD=OE+ED=R₁ sin θ+R₂ cos 2θ

DH=R₁ cos θ

CH=R₂ sin 2θ

CD=DH+CH=R₁ cos θ+R₂ sin 2θ

For calculation of DF in the right triangle of CDF, one can write:

DF=\sqrt{L²−(R₁ cos θ+R₂ sin 2θ)²}

OF=OD+DF=R₁ sin θ+R₂ cos 2θ+\sqrt{L²−(R₁ cos θ+R₂ sin 2θ)²}

With this formula, one can find length of OF or position of the upper end F of the piston connecting rod; however it would be more beneficial if one replaces L (length of piston connecting rod) and cogshaft R₂ with their relation to R₁. So, taking L=nR₁ and R₂=mR₁ and replacing them in the above formula, one obtains a final formula as follows:

OF=R₁[sin θ+m cos 2θ+\sqrt{n²−(cos θ+m sin 2θ)²}] Formula 1

By knowing the length of two shafts (crankshaft throw R₁ and cogshaft linkage R₂) and L (piston connecting rod), one can find length of OF or position of upper end of piston connecting rod for different angles of θ and find the angle at which OF is maximum, i.e., at top dead center or the point of the beginning of the intake stroke. By symmetry, if one takes θ₁ as the angle at beginning of the intake stroke, the angle at beginning of the combustion stroke will be 180°−θ₁. By Formula 1, one can find length of OF at angles of θ=90° (at end of intake) and θ=270° (at end of combustion) in all situations as followings:

θ=90° OF=R₁(n+1−m) Formula 2

θ=270° OF=R₁(n−1−m) Formula 3

It is apparent that in all situations difference in length of the power stroke from the intake stroke is 2 R₁.

Expansion Ratio.

Efficiency is related to the ratio of volume of cylinder at its largest displacement to its smallest displacement, or when the piston is at its maximum distance from the top of the cylinder to when it is closest to the top of the cylinder. Because the diameter of cylinder is constant, this ratio is approximately equal to the ratio of the length of cylinder above the piston in these two states. In conventional engines, compression and expansion are the same because change of volume is the same during these two cycles. In present invention, these two states are different and since the power is produced during combustion cycle and expansion of gas is much more than in the compression cycle, the term “expansion ratio” is used herein for expressing the efficiency of the engine. Naturally, the expansion ratio would be calculated as a product of the compression ratio as used in conventional engines multiplied by ratio of the combustion stroke distance to the compression stroke distance. For example if we take 8 as compression ratio (which is prevalent in many car engines today) and a ratio of combustion to compression stroke of 3, the expansion ratio would be 8×3=24, which can be used for calculating efficiency.

Expansion ratio depends on m (ratio of the length of cogshaft linkage R₂ to crankshaft throw R₁) and n (ratio of piston connecting rod L to R₁). Referring to FIGS. 2 and 7 and using Formula 1, the length of OF can be calculated for different angles of rotation (θ). The angle at which OF is maximum is the angle of beginning of the intake stroke. The length of OF at the end of the intake stroke is when θ=90°, which can be easily calculated using (OF=R₁(n+1−m)). Naturally length of the intake (or compression) stroke would be length of OFₘₐₓ, which was calculated above, minus length of OF at the end of intake, which can be calculated. The length of the combustion stroke will be obtained by adding 2 R₁ to the length of intake stroke (as mentioned above). So, by dividing, one can easily obtain ratio of the combustion to compression strokes, and by multiplying it with compression ratio, one can obtain the expansion ratio.

Here are a few illustrative examples:

### Example 1

### n=4, m=1

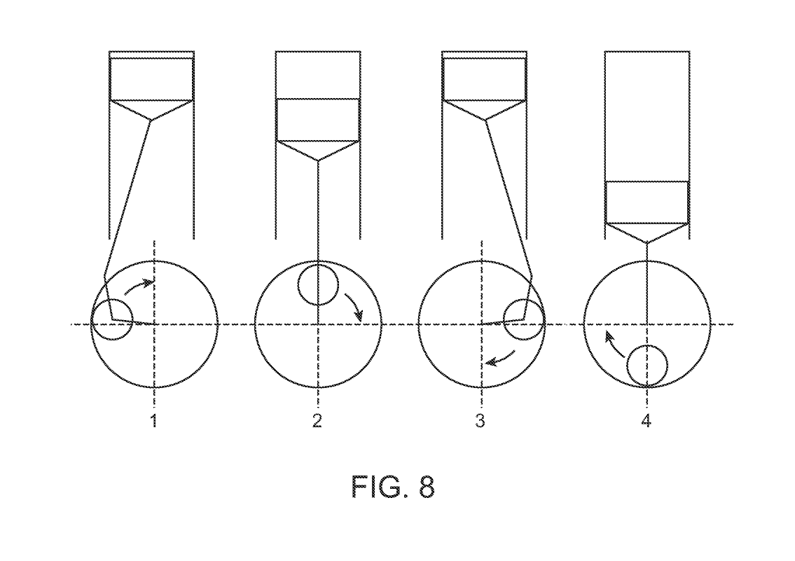

In this example, OFₘₐₓ=4.90 R₁ and appears at the angle of θ=5°. By Formulas 2 and 3, OF at end of intake=4 R₁ and at the end of combustion=2 R₁, so the length of intake=4.90 R₁−4 R₁=0.90 R₁ and length of combustion=2.90 R₁. Thus, the ratio of combustion to intake is (2.90/0.90)=3.22 and if the compression ratio is 8, expansion ratio will be 3.22×8=25.76. FIG. 8 schematically shows four different cycles of this example.

### Example 2

### n=4, m=0.8

In this example, OFₘₐₓ=4.72 R₁ at angle of θ=10°, and OF at the end of intake=4.2 R₁. The length of the intake stroke=0.52 R₁, and the length of the combustion stroke=2.52 R₁ Thus, the ratio of combustion to intake=(2.52/0.52)=4.84. If the compression ratio is 8, then the expansion ratio is 4.84×8=38.72.

### Example 3

### n=3 m=1

In this example, OFₘₐₓ=3.84 R₁ at angle θ=4°, and OF at the end of intake=3 R₁ and at the end of combustion=R₁, thus, the length of the intake stroke=0.84 R₁, and the length of the combustion stroke=2.84 R₁. The ratio of combustion to intake lengths=(2.84/0.84)=3.38, and with a compression ratio of 8, the expansion ratio=3.38×8=27.

### Example 4

### n=3 m=0.8

In this example OFₘₐₓ=3.66 at angle θ=7°, and OF at the end of the intake stroke=3.2 R₁ and at the end of the combustion stroke=1.2 R₁. Thus, the length of the intake stroke=3.66 R₁−3.2 R₁=0.46 R₁, and the length of the combustion stroke=2.46 R₁. The ratio of combustion to intake lengths=(2.46/0.46)=5.35, and the expansion ratio with a compression ratio of 8=5.35×8=42.8.

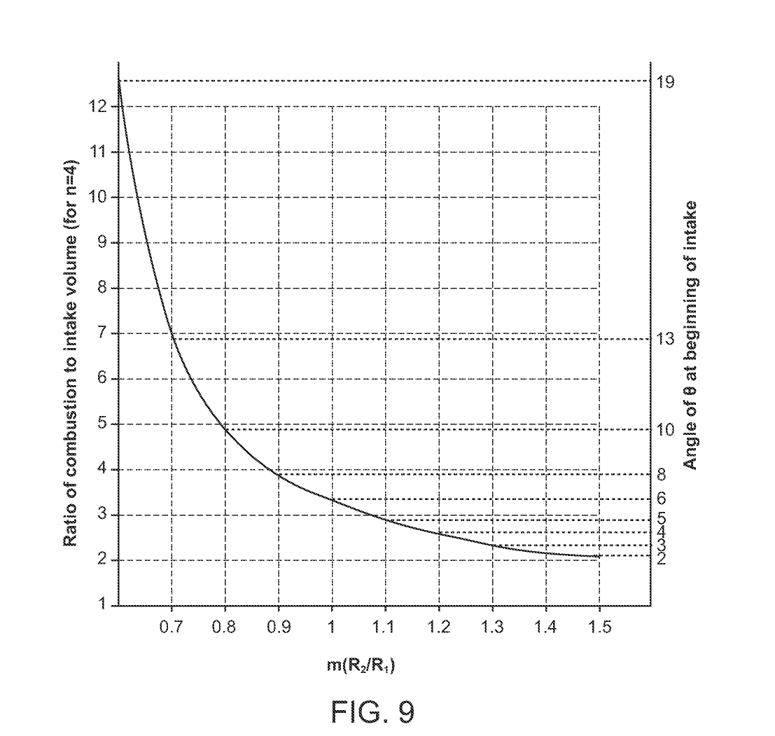

It is apparent that by proper selection of “n” and “m”, one can achieve any expansion ratio that is desired. FIG. 9 for situations where n=4, the Y axis shows ratio of combustion to intake stroke volume for different values of “m” (ratio of lengths of cogshaft linkage to crankshaft throw) on X-axis. When these values are multiplied by the compression ratio of 8, this gives approximate expansion ratios. The right ordinate shows angles of θ for OFₘₐₓ.

Theoretically, if m is such that ratio of combustion to intake stroke is relatively high, the efficiency will be higher; however, practically, if the ratio increases, other deleterious factors such as dropping of gas pressure below the atmospheric and increased fraction will intervene which will offset the benefit. Thus, in one embodiment, the ratio of the length of the cogshaft linkage and crankshaft throw is between 0.7 and 1.5, and in another embodiment, the ratio is approximately 1, meaning it can be between 0.9 and 1.1.

In a similar vein, one embodiment includes a compression ratio of between 7 and 9, and especially about 8. Taking into account these compression ratios, and various values of m, one embodiment of the invention includes a ratio of the displacement of piston at the power stroke to displacement at the compression stroke is between 2 and 7, and in another embodiment, between 3 and 4. Correspondingly, this in turn would give expansion ratios between 16 and 56, and between 24 and 32.

Arrangement of Cylinders.

In the illustrative embodiment under discussion, the outer cogwheel circumference is three times larger than the inner cogwheel circumference. Thus, during one rotation of the crankshaft throw (R₁), the inner cogwheel goes through three complete rotations, and cogshaft (R₂) attached to it also goes through three similar rotations during one complete rotation of the crankshaft.

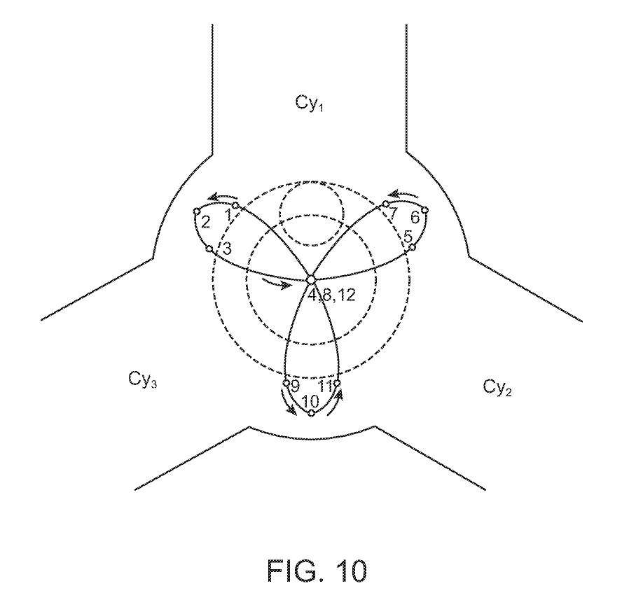

FIG. 10 is a plot of the path taken by the axis of the cogshaft journal (where the connecting rod is connected) as the crankshaft revolves. The plot illustrates that the locus of the axis of the cogshaft journal during movement of the crankshaft describes a three pronged curve with three identical lobes, for every one of which a cylinder can be installed, e.g., at Cy₁, Cy₂, and Cy₃. Each of the numbered points corresponds to start or end of different cycles of three cylinders (the end of each cycle corresponds to the start of the next cycle) as follows:

1: End of Exhaust Stroke of Cy1 or start of its Intake Stroke.
2: End of Combustion Stroke of Cy2 or start of its Exhaust Stroke.
3: End of Compression Stroke of Cy3 or start of its Combustion Stroke.
4: End of Intake Stroke of Cy1 or start of its Compression Stroke.
5: End of Exhaust Stroke of Cy2 or start of its Intake Stroke.
6: End of Combustion Stroke of Cy3 or start of its Exhaust Stroke.
7: End of Compression Stroke of Cy1 or start of its Combustion Stroke.
8: End of Intake Stroke of Cy2 or start of its Compression Stroke.
9: End of Exhaust Stroke of Cy3 or start of its Intake Stroke.
10: End of Combustion Stroke of Cy1 or start of its Exhaust Stroke.
11: End of Compression Stroke of Cy2 or start of its Combustion Stroke.
12: End of Intake Stroke of Cy3 or start of its Compression Stroke.

It should be noted the three points of 4, 8, and 12 overlap in the present example in which crankshaft throw and the cogshaft linkage have equal lengths (R1=R2), but when R1 R2 (i.e., m≠1) these points are separate.

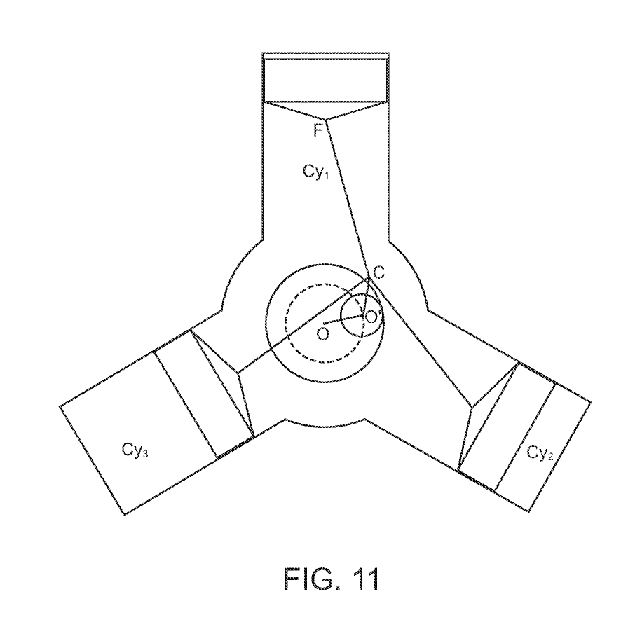

FIG. 11 is a schematic drawing of an embodiment of the present invention in which three cylinders are evenly spaced around a circle, each cylinder being 120° apart from the others. The inner ends of the piston connecting rods are connected to the cogshaft journal at point C. Line OO′ represents the crankshaft throw or shaft R₁, and line O′ C represents the cogshaft linkage shaft R₂. Line CF represents a piston connecting rod. In FIG. 11, the locus of movement of distal end of the cogshaft linkage (point C on FIG. 11 and point 74 on FIG. 1) is a three pronged curve with three similar prongs separated at a 120 degree angle with respect to each adjacent one (FIG. 10). Thus, three cylinders can be arranged in a radial fashion around the crankshaft, each one 120 degrees apart from adjacent one, and all their piston connecting rods can be connected to the distal end of the cogshaft linkage as appears at point C on FIG. 11.

During one complete excursion of point C (the connection point of the piston connecting rods to the end of inner cogshaft linkage) through the three-pronged curve, all the three cylinders (Cy1, Cy2, and Cy3) go through all of their four cycles.

Efficiency.

Efficiency of internal combustion engines in physics textbooks is: e=1−1/(V₂/V₁)^{γ-1} where e is efficiency, V₂ is final volume at the end of expansion, V₁ is volume at beginning of combustion (smallest volume) and γ is ratio of molar heat capacities. With a typical compression ratio of 8 in regular engines and γ=1.4, the theoretical efficiency calculated with the formula will be 56%. But, actual efficiency is more like 15% to 20% because of such effects as friction, heat loss to the cylinder walls, and incomplete fuel combustion. With an engine employing a hypocycloidal crank assembly to provide different stroke volumes, if the expansion ratio is raised to 30, theoretical efficiency with this formula will be 74%, a substantial gain. However, this number will be affected by more expansion, thus more cooling of the exhaust gas, decreased heat loss, and more complete combustion of fuel.

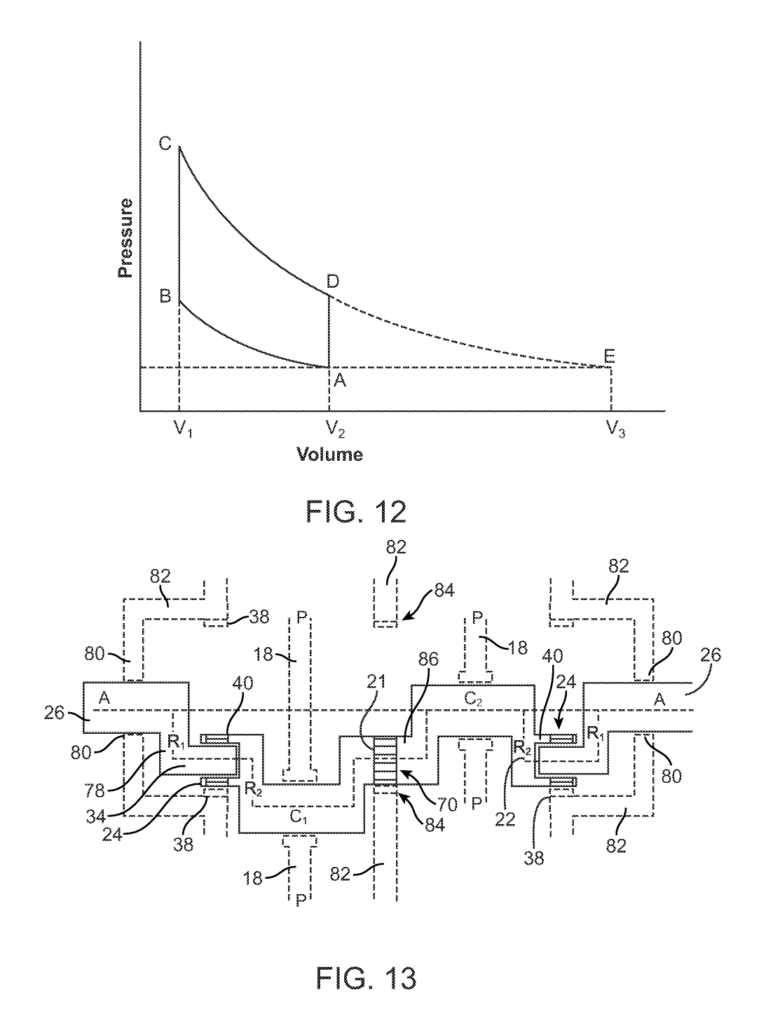

FIG. 12 shows a pressure-volume chart on the cycles of a cylinder in an engine. The abscissa or X axis is volume and the ordinate or Y axis is pressure. In a typical engine, point A is beginning of the compression stroke, and point B is its end. At point B, there is ignition of the fuel-air mixture, and the combustion increases the pressure to point C. At point C, the high pressure forces the piston downward to point D, which increases volume within the cylinder from V₁ again to V₂ and decreases pressure to the point D. Thus, area ABCD corresponds to the useful energy in conventional engines. However, in the present invention, the combustion cycle has a larger expansion volume due to the hypocycloidal movement of the crankshaft assembly, thus increasing the combustion volume to V₃. Area DEA is the incremental useful energy which adds to efficiency of the engine.

FIG. 13 is a view of an embodiment of the present invention depicting the crankshaft assembly of a six cylinder engine with two adjacent compartments of three cylinders radially disposed from the axis of crankshaft A (26). Crank throw 78 and R1 extending from the crankshaft A (26) engages a cogwheel bearing 40 fixed to cogshaft link R₂ and cogshaft journal C₁ (28). Three piston connecting rods P (18) of one compartment are connected to the cogshaft journal at C₁ and, similarly, the three piston connecting rods P of the other compartment are connected to C₂. The cogwheels, cogwheel bearings, cogshaft links and cogshaft journals which as an integral unit serve the combined compartments is depicted as R₂ C₁ C₂ R₂. Also depicted is engine housing 82 having main bearings 80 for the crankshaft. The crankshaft throw distal journal 34 is rotatably joined to cogwheel bearing 40 within inner cogwheel 24. The housing 82 supports the outer annular cogwheels 20, including an interbank annular cogwheel 84. The teeth 38 of the interbank annular cogwheel engage the teeth 70 of the interbank inner cogwheel 21 on the interbank cogwheel connection 86 which connects the cogwheels of the two banks and provides stability and support for the cogshaft.

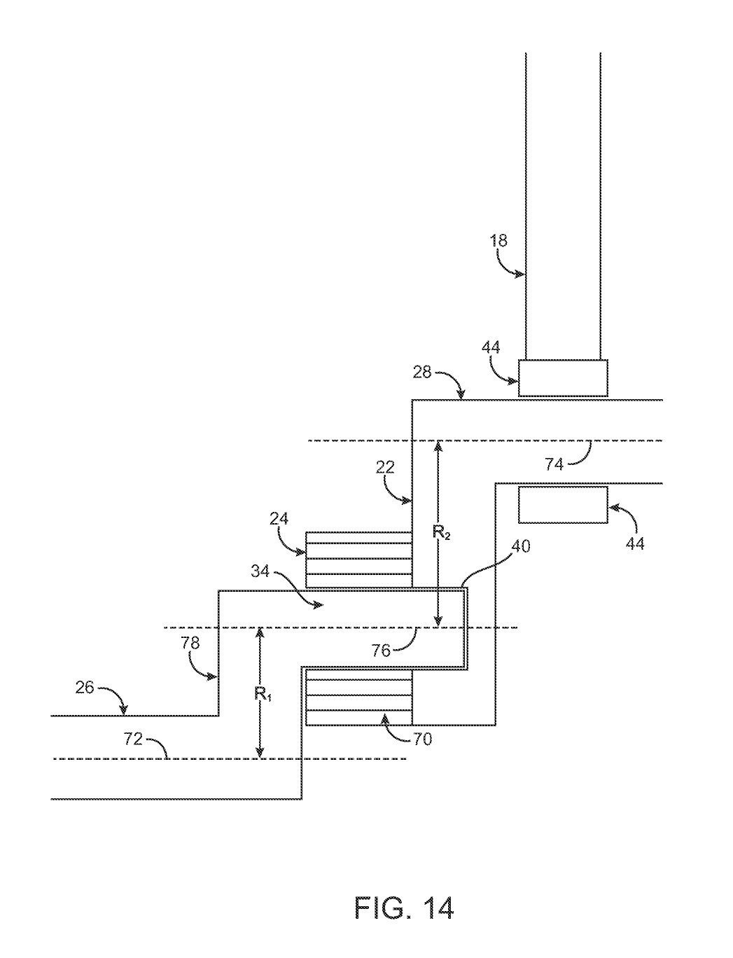

FIG. 14 is an expanded view of the crankshaft/crank throw and cogshaft linkage assembly. Crankshaft 26 has crankshaft throw 78 extending from it, and crankshaft throw includes a distal journal 34. The distance between the axis of rotation 72 of the crankshaft and the cogshaft bearing axis 76 is R₁. Rotatingly coupled to crankshaft throw distal journal 34 by cogwheel bearing 40 is inner cogwheel 24. Integral with cogwheel 24 is cogshaft linkage 22 to which is connected cogshaft journal 28. The distance between the cogshaft bearing axis 76 and the connecting rod bearing axis 74 is R₂. Piston connecting rod 18 is connected to cogshaft journal 28 by connecting rod bearing 44.

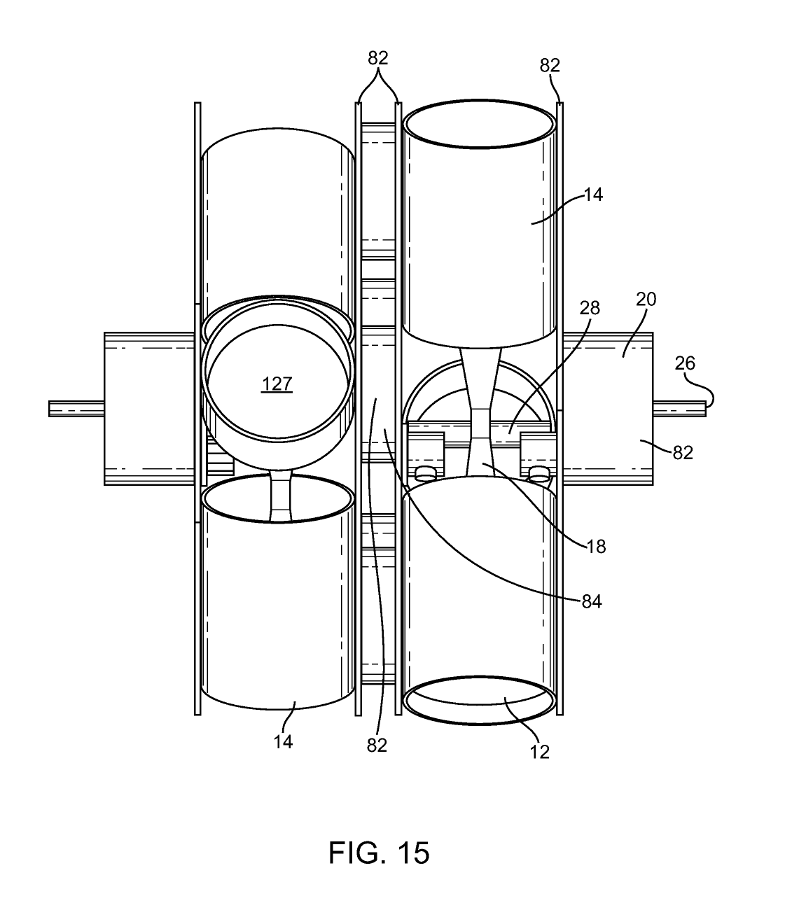

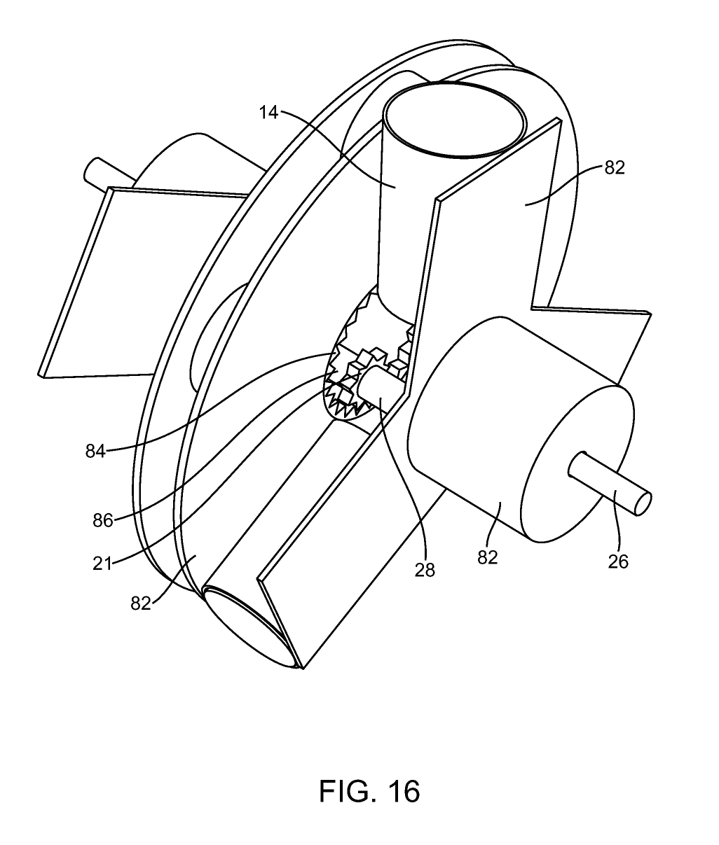

FIG. 15 is a side view of a two-bank depiction of the hypocycloid crankshaft assembly in which pistons 12 are within cylinders 14 within engine housing 82. Engine housing 82 includes an extension outside of the cylinder banks that houses an outer annular cogwheel 20, an inner cogwheel and cogshaft the crank throw and a main bearing for crankshaft 26. Connecting rod18 connects the piston to the cogshaft journal 28. Within the housing 82 between the banks of cylinders is interbank annular cogwheel 84, to which is connected the interbank inner cogwheel 21 and the interbank cogwheel connection, better shown in the next figure.

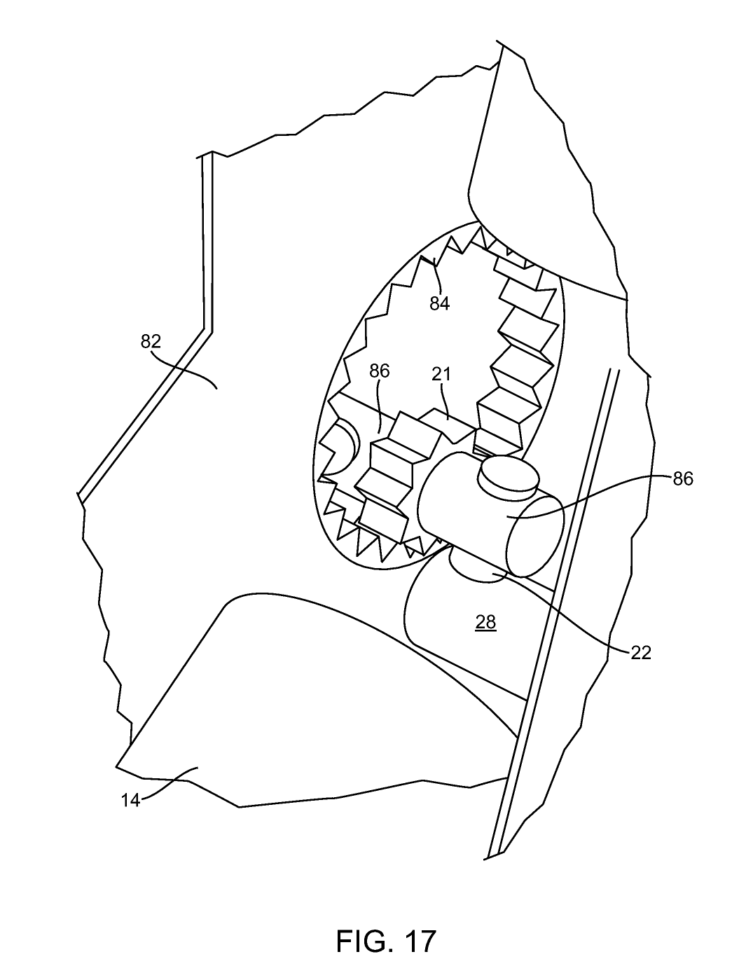

FIG. 16 is a perspective view of a two-bank depiction of the hypocycloid crankshaft assembly showing the engine housing 82 with crankshaft 26 extending from one end, cylinders 14 being radially spaced around the crankshaft axis, and cogshaft journal 28 extending as interbank cogshaft connection 86 between banks of cylinders. Integral with interbank cogshaft connection 86 is interbank inner cogwheel 21 which engages interbank annular cogwheel 84.

FIG. 17 is an expanded perspective view of the interbank hypocycloid gearing, depicting a portion of the interbank housing 82 within which is interbank annular cogwheel 84. Meshing with interbank cogwheel 84 is interbank inner cogwheel 21 which is connected to interbank cogwheel connection 86. At either end of the interbank cogwheel connection 86 is a cogshaft linkage 22 connecting with a cogshaft journal 28.

It is to be understood that the figures provided herein are not drawn to scale, but are for illustrative purposes only, and the thickness of the lines in the figures bears no significance.

Although the present invention has been described in terms of specific embodiments it is anticipated that alterations and modifications thereof will no doubt become apparent to those skilled in the art. It is therefore intended that the following claims be interpreted as covering all such alterations and modification as fall within the true spirit and scope of the invention.

What is claimed is:

1. A four-cycle internal combustion engine assembly comprising:
a housing assembly;
a crankshaft disposed in the housing, the axis of rotation of the crankshaft being generally parallel to the orientation of the crankshaft;
at least three cylinders radially disposed about the crankshaft axis;
the crankshaft having one or more throws;
an inner cogwheel rotatably mounted on the journal of each throw;
each inner cogwheel having a linkage and a journal at the distal end of each linkage, each inner cogwheel having a linkage extending therefrom and a journal at the distal end of the linkage;
an outer cogwheel within the housing and oriented concentric with the axis of rotation of the crankshaft;
a plurality of cylinders fixed to the housing;
each cylinder encompassing a piston having a connecting rod, one end of which is pivotally connected to the piston, the other end being rotatably mounted to a journal on the inner cogwheel linkage, such that as the crankshaft rotates, the axis of the lower end of the connecting rod (or cogshaft linkage journal) rotates hypocycloidally with respect to the axis of the crankshaft.

2. The engine of claim 1 wherein the ratio of the length of the cogshaft linkage and crankshaft throw is between 0.7 and 1.5.

3. The engine of claim 1 wherein the ratio of the length of the cogshaft linkage and crankshaft throw is about 1.

4. The engine of claim 1 wherein the ratio of the displacement of piston at the power stroke to displacement at the compression stroke is between 2 and 7.

5. The engine of claim 1 wherein the ratio of the displacement of piston at the power stroke to displacement at the compression stroke is between 3 and 4.

6. The engine of claim 1 wherein the number of cylinders is a three or a multiple of three.

7. The engine of claim 1 wherein the ratio of number of teeth of outer cogwheel to inner cogwheel is 3.

8. A crankshaft assembly for a radial internal combustion four-cycle engine having at least three cylinders and a housing for the crankshaft assembly, comprising:
a crankshaft disposed in the engine housing, the axis of rotation of the crankshaft being generally parallel to the orientation of the crankshaft;
an annular outer cogwheel mounted within the housing and being oriented concentric with the axis of rotation of the crankshaft;
the crankshaft having at least one throw arm extending perpendicularly from the crankshaft axis;
an inner cogwheel rotatably connected to each throw arm, engaging the annular cogwheel and having a cogshaft extending therefrom perpendicular to its axis of rotation;
each cylinder having a piston disposed therein, with one end of the piston being pivotably connected to the outer end of a connecting rod; and
the inner end of each connecting rod being rotatably attached to a cogshaft journal;
whereby the crankshaft assembly allows the inner end of the connecting rod to move hypocycloidally with respect to the axis of the crankshaft, thus enabling a different piston displacement during the intake cycle compared to the combustion cycle of a four-cycle engine.

9. A crankshaft assembly for a radial internal combustion engine having at least three cylinders and a housing for the crankshaft assembly, comprising:
a crankshaft disposed in the engine housing, the axis of rotation of the crankshaft being generally parallel to the orientation of the crankshaft,
the housing having an integral annular cogwheel oriented concentric with the axis of rotation of the crankshaft,
the crankshaft having at least one throw arm extending perpendicularly from the axis,
an inner cogwheel rotatably connected to each throw arm and engaging the annular cogwheel,
each cylinder having a piston disposed therein, with one end of the piston being pivotably connected to the outer end of a connecting rod,
the inner end of each connecting rod being rotatably attached to a cogshaft journal which attaches perpendicular to the end of cogshaft which itself extends from the inner cogwheel perpendicular to its axis of rotation,
whereby the crankshaft assembly allows the inner end of the connecting rod to move hypocycloidally with respect to the axis of the crankshaft, thus enabling a different piston displacement during the intake stroke as opposed to the combustion stroke.

10. In a radial internal combustion engine having a housing, a plurality of pistons each pivotally connected to one end of a connecting rod, each connecting rod having a medial end spaced apart from the end connected to the piston, a crankshaft having throw arm to accommodate each piston, and a linkage between the crankshaft and the connecting rod, the improvement which comprises:
the linkage for each piston comprising an inner cogwheel rotatably mounted on the throw arm,
a cogshaft integral with each inner cogwheel, to which is rotatably connected the medial end of the connecting rod;
and an annular cogwheel within the housing with which each inner cogwheel is engaged;
such that the medial end of the connecting rod moves hypocycloidally with respect to the axis of the crankshaft to enable a different piston displacement during the compression stroke as compared to the combustion stroke.
